(19) United States
(12) Patent Application Publication
(10) Pub. No.: US 2025/0206545 A1
(43) Pub. Date: Jun. 26, 2025

(54) CONVEYANCE DEVICE AND CONVEYANCE METHOD

(71) Applicant: NHK SPRING CO., LTD., Yokohama-shi (JP)

(72) Inventor: Kenichiro NAKANO, Yokohama-shi (JP)

(73) Assignee: NHK SPRING CO., LTD., Yokohama-shi (JP)

(21) Appl. No.: 18/978,193

(22) Filed: Dec. 12, 2024

(30) Foreign Application Priority Data
Dec. 20, 2023 (JP) 2023-214908

(51) Int. Cl. B65G 51/02

(52) U.S. Cl. CPC B65G 51/02

(57) ABSTRACT

A conveyance device according to one embodiment is a conveyance device that conveys a part by air. The conveyance device includes a conveying tube that has a first end portion and a second end portion, in which a part is conveyed the first end portion to the second end portion, and a control unit which controls supply of the air to be supplied from the first end portion and stopping of the supply of the air, to stop the supply of the air at least once while the part is being conveyed.

### CROSS-REFERENCE TO RELATED APPLICATIONS

This application is based upon and claims the benefit of priority from prior Japanese Patent Application No. 2023-214908 filed Dec. 20, 2023, the entire contents of which are incorporated herein by reference.

### BACKGROUND OF THE INVENTION

### 1. Field of the Invention

The present invention relates to a conveyance device and a conveyance method.

### 2. Description of the Related Art

Conventionally, the transportation of parts using air has been known as one method of transporting parts. For example, in the publication of JP H09-71324 A, an air-powered spring supply device is disclosed, which uses compressed air to untangle the coils of a number of compressed springs stored in a tank, and then extracts the coils one by one through a pipe.

As another example, in the publication of JP 2016-137974 A, a conveyance device for conveying an object to be conveyed is disclosed, which has an air gun that performs air suction and eject using compressed air as a power source, and a conveying tube installed on the air discharge side of the air gun, and characterized in that the conveying tube is formed as an approximately cylindrical space with an open surrounding by arranging multiple strip members so that their cross sections are approximately circular, and the to-be-conveyed object is transferred along the longitudinal direction of the strip members within the space surrounded by the strip members due to the inertia force caused by the suction of the air gun.

In spite of the presence of the devices disclosed in the above-described documents, there still are various drawbacks with the transportation of parts. As one of the drawbacks, for example, in the case of feeding a part into a jig set at the destination, when the pressure of the supplied air is excessively high, the parts may bounce off the jig and it may not be possible to place the part in the predetermined position.

### BRIEF SUMMARY OF THE INVENTION

An object of the present invention is to provide a conveyance device and conveyance method that can stably convey parts.

One embodiment of the conveyance device is a conveyance device that conveys parts by air. The conveyance device includes a conveying tube that has a first end portion and a second end portion, in which a part is conveyed the first end portion to the second end portion, and a control unit which controls supply of the air to be supplied from the first end portion and stopping of the supply of the air, to stop the supply of the air at least once while the part is being conveyed.

The control unit may control the stopping of the supply the of air so that the number of times of the supplying of air is greater than the number of times the supply of the air is stopped while the part is being conveyed from the first end portion to the second end portion.

The control unit may control the stopping of the supply of air so that a period of the supply of the air per one time and a period of stopping the supply of the air per one time are equal to each other. The control unit may control the stopping of the supply of the air so that a period of the supply of the air per one time is shorter than a period of stopping the supply of the air per one time.

The pressure of the air supplied may be higher than or equal to a pressure required for the part to start moving in the conveying tube. The conveyance device may further comprise a table connected to the conveying tube and including a pocket in which the part is to be placed, and an air pipe connected to the table, which supply the air to the conveying tube via the pocket.

The control unit may include a regulation portion installed in the air pipe, which switches between the supply of the air to be supplied to the conveying tube and stopping of the supply. The conveyance device may further comprise a nozzle provided at the second end portion and having an inner diameter that reduces toward a distal end which ejects the part. The control unit may supply the air at such intervals that a residual pressure of the air in the conveying tube does not become zero.

A conveyance method of another embodiment is a conveyance method for conveying a part by air. The conveyance method includes controlling supply of the air to be supplied to a conveying tube through which the part is conveyed and stopping of the supply of the air. The controlling comprises stopping the supply of the air at least once while the part is being conveyed through the conveying tube.

The controlling may comprise stopping the supply of the air so that the number of times of the supply of the air is greater than the number of times of the stopping of the supply of the air while the part is being conveyed. The controlling may comprise stopping the supply of the air so that a period of the supply of the air per one time and a time for the stopping of the supply of the air per one time become equal to each other. The controlling may comprise stopping the supply of the air so that a period of the supply of the air per one time is shorter than a period of the stopping of the supply of the air per one time. The controlling may comprise supplying the air at such intervals that a residual pressure of the air in the conveying tube does not become zero.

According to the conveyance device and conveyance method with the above-described configuration, parts can be conveyed stably.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a structural diagram schematically showing a conveyance device according to one embodiment.

FIG. 2 is a cross-sectional view partially showing a table shown in FIG. 1.

FIG. 3 is a timing chart showing an example of control by a control unit.

FIG. 4 is a timing chart showing another example of the control by the control unit.

### DETAILED DESCRIPTION OF THE INVENTION

One embodiment of the present invention will now be described with reference to the accompanying drawings. In order to make the description clearer, the size and shape of each part in the drawings may be schematically represented by changing them from those of the actual implementation.

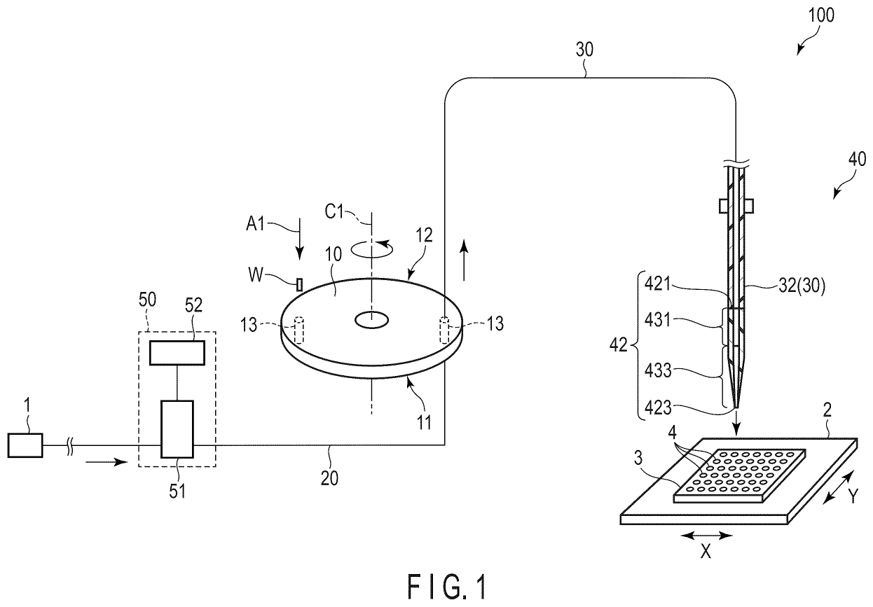

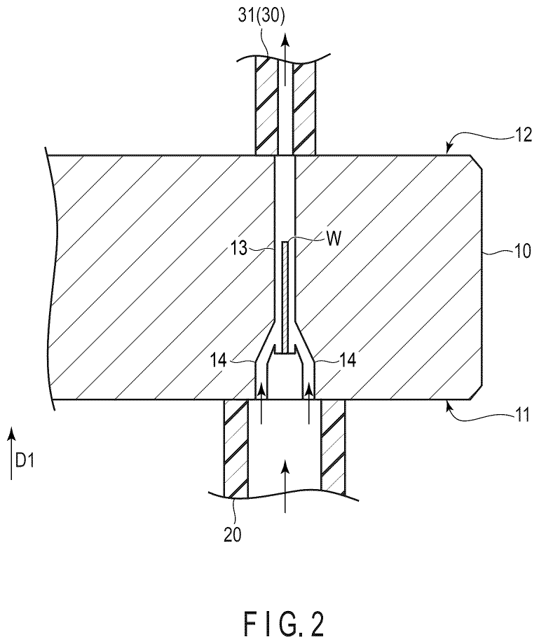

FIG. 1 is a structural diagram schematically showing a conveyance device 100 of this embodiment. FIG. 2 is a partial cross-sectional view of a table 10 shown in FIG. 1. In FIG. 2, the area around a pocket 13, where an air pipe 20 and a conveying tube 30 are connected to each other, is shown in an enlarged view.

The conveyance device 100 of this embodiment conveys parts by air. In FIGS. 1 and 2, a workpiece W is shown as an example of parts. The workpiece W is a part to be conveyed by the conveyance device 100. The workpiece W is, for example, a small part, but this is not limited to that used in this example. The workpiece W includes, for example, a rod shape (in one example, a cylindrical shape) that extends along an axial line. The diameter of workpiece W is, for example, between 0.05 mm and 1.5 mm. The workpiece W is, for example, a probe.

The workpiece W may be made up of a single component or multiple components. The air used to convey the workpiece W is, for example, compressed air. The air is supplied from a supply source 1 such as a compressor.

The conveyance device 100 conveys the workpiece W towards a jig 3, which is placed on a stage 2 shown in FIG. 1. The stage 2 is configured to be movable along an X direction and a Y direction, which orthogonally intersects the X direction.

With the configuration described above, the jig 3 moves along the X direction and the Y direction together with the stage 2. The jig 3 has, for example, a flat plate shape. The jig 3 includes a plurality of recess portions 4 formed in a grid pattern along the X and Y directions. The workpiece W can be fed into each of the recess portions 4 from the conveyance device 100.

The conveyance device 100 comprises a table 10, an air pipe 20, a conveying tube 30, an ejection unit 40, and a control unit 50.

The table 10 is connected to the air pipe 20 and the conveying tube 30. In the example shown in FIG. 1, the table 10 has a circular shape. The table 10 is supported so as to be rotatable around a rotation axis C1 (shown in FIG. 1). The table 10 may as well be referred to as an index table in some cases. Here, the direction along the rotation axis C1 is defined as a direction D1 (shown in FIG. 2).

The table 10 has a first surface 11 and a second surface 12 on an opposite side to the first surface 11. The first surface 11 corresponds to the surface to which the air pipe 20 is connected, and the second surface 12 corresponds to the surface to which the conveying tube 30 is connected.

The table 10 further includes a pocket 13 in which the workpiece W can be placed. For example, there may be a plurality of (for example, two) pockets 13 formed therein along a circumferential direction around the rotation axis C1. Note that there may be one pocket 13 or three or more pockets formed in the table 10.

The pockets 13 have such a shape elongated along the direction D1, as shown in FIG. 2. The length of the pockets 13 along the direction D1 is greater than the length of the workpieces W. The pockets 13 have a base which the workpiece W is placed. The pockets 13 are formed open toward the second surface 12.

The table 10 includes a plurality of (for example, two) flow channels 14 each connecting the first surface 11 and the respective one of the pockets 13. Note that there may be only one channel 14 formed or three or more channels 14 formed therein. The plurality of flow channels 14 are formed along the direction D1. To these flow channels 14, air is supplied from the air pipe 20. The flow channels 14 are located on an inner side of the air pipe 20.

In the example shown in FIG. 2, the air pipe 20 is connected to the first surface 11, and the conveying tube 30 is connected to the second surface 12. To one end of the air pipe 20, the supply source 1 (for example, a compressor) is connected as shown in FIG. 1

The pressure of the air supplied from the supply source 1 is constant, for example. The pressure of the air is equal to the pressure supplied to the conveying tube 30. The pressure of the air is greater than or equal to the pressure required for the workpiece W to start moving in the conveying tube 30.

For example, the air pressure is equal to the pressure required for the workpiece W to start moving inside the conveying tube 30, or a pressure that is slightly higher, for some extra adequacy, than the pressure required for the workpiece W to start moving. The air pressure is changed as appropriate according to the workpiece W to be conveyed, the material and size of the conveying tube 30, or the like. By adjusting the air pressure appropriately, air consumption can be reduced.

The air pipe 20 may be formed from a resin material or a metal material. The air supplied from the air pipe 20 is supplied to the conveying tube 30 via the flow channel 14 and the respective pocket 13. In FIG. 2, the flow of air is indicated by an arrow. The workpiece W is placed in the pocket 13 from a second surface 12 side as indicated by an arrow A1 in FIG. 1.

The control unit 50 controls the supply of air from the supply source 1 to the conveying tube 30 and the stopping of the supply of air. The control unit 50 includes a regulation portion 51 and a control portion 52 that controls the regulation portion 51.

The control portion 52 is configured to be able to control the regulation portion 51. The control portion 52 is, for example, a computer, but this is not limited to the case of this example. The control portion 52 is connected to the regulation portion 51 so as to be able to carry out communications therebetween. The regulation portion 51 switches between the supply of air to the conveying tube 30 and stopping of the supply. More specifically, the regulation portion 51 switches between the supply of and the stopping of the supply in response to a control signal from the control portion 52.

The regulation portion 51 is installed in the air pipe 20. In other words, the air pipe 20 includes the piping connecting the supply source 1 and the regulation portion 51 to each other, and the piping connecting the regulation portion 51 and the table 10 to each other.

The regulation portion 51 is, for example, an electro-pneumatic regulator. The regulation portion 51 is, in some other example, an air valve, but is not limited to the case of this example. For example, In the case of an electro-pneumatic regulator, it can switch accurately even when the interval between the supply and stopping of the air is short, in response to the control signal from the control portion 52.

The conveying tube 30 conveys the workpiece W from the table 10 to the jig 3. The conveying tube 30 is formed from PEEK, for example, but it may as well be formed from some other resin material or from a metal material.

The conveying tube 30 is formed, for example, into a cylindrical shape. The size of the conveying tube 30 is changed as appropriate according to the size of the workpiece W or the like. The length of the conveying tube 30 is changed as appropriate according to the distance between the table 10 and the stage 2 or the like.

The conveying tube 30 has a first end portion 31 (shown in FIG. 2) and a second end portion 32 (shown in FIG. 1) located on an opposite side to the first end portion 31. The first end portion 31 is connected to the table 10. The workpiece W is conveyed in the conveying tube 30 from the first end portion 31 toward the second end portion 32 by air.

The ejection unit 40 is provided on the second end portion 32. The ejection unit 40 includes a nozzle 42. The nozzle 42 is connected to the second end portion 32 by any means. The workpiece W is conveyed from the second end portion 32 of the conveying tube 30 to the nozzle 42.

The nozzle 42 has a tubular shape. The nozzle 42 is, for example, a capillary. The nozzle 42 is formed, for example, of ceramic. The nozzle 42 has a proximal end 421 connected to the second end portion 32 and a distal end 423 that ejects workpieces W.

The inner circumferential surface of the nozzle 42 has a straight portion 431 provided on a proximal end 421 side of and a tapered portion 433 provided on a distal end 423 end. The straight portion 431 is formed to have a uniform inner diameter.

The tapered portion 433 is formed so that the inner diameter becomes smaller towards the distal end 423. The inner diameter of the proximal end 421 of the nozzle 42 is larger than the inner diameter of the conveying tube 30, for example. The inner diameter of the proximal end 421 of the nozzle 42 is 0.7 mm, and the inner diameter of the distal end 423 is 0.16 mm. Note that the size of the nozzle 42 is changed as appropriate according to the size of the workpiece W and the like.

Next, the transport of the workpiece W by air will be explained. Here, the transport of a single workpiece W will be explained.

First, the workpiece W is inserted into a pocket 13 of the table 10 from a second surface 12 side. When the workpiece W is inserted into the pocket 13, the table 10 rotates 180 degrees around the rotation axis C1. Then, the air pipe 20 and the conveying tube 30 are each connected to the pocket 13 into which the workpiece W is inserted. At this time, a workpiece W may as well be inserted to the other pocket 13.

Next, air is supplied from the supply source 1 to the table 10 via the air pipe 20. More specifically, the supplied air is sent to the pocket 13 via the regulation portion 51. When the air is supplied to the pocket 13, the workpiece W starts to move due to the air and is conveyed along the air in the conveying tube 30 from the first end portion 31 to the second end portion 32. At this time, there is only one set of workpiece W in the conveying tube 30.

When the workpiece W is conveyed up to the second end portion 32, the workpiece W is allowed to pass through the nozzle 42 and ejected from the distal end 423 of the nozzle 42 together with the air.

The workpiece W is then fed into a recess portion 4 of the jig 3 located below the nozzle 42. The workpiece W that is placed in the recess portion 4 is inverted upside down with respect to the workpiece W placed in the pocket 13.

Once the feeding of the workpiece W to the jig 3 is completed, the positioning of the stage 2 is carried out to align it with the recess portion 4 into which the next workpiece W will be placed. The table 10 then rotates and the next workpiece W is conveyed.

The series of flows of process described above takes less than one second per single workpiece W. Here, an example of the case where the positioning is achieved by moving the stage 2 is explained, but it may as be possible to achieve the positioning by moving the ejection unit 40 to align it with the recess portion 4 into which the workpiece W is to be fed.

Next, an example will be provided, of how the control portion 52 is controlled during the process of transporting a single workpiece W from the first end portion 31 to the second end portion 32.

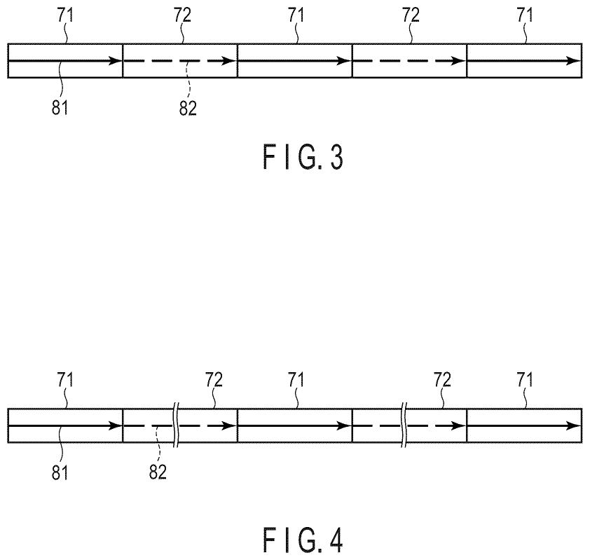

FIG. 3 is a timing chart showing an example of control by the control portion 52. The control portion 52 stops the supply of air to the conveying tube 30 at least once while the workpiece W is conveyed from the first end portion 31 to the second end portion 32.

In other words, the control portion 52 controls the regulation portion 51 so as to stop the air supply to the conveying tube 30 at least once. If the conveying tube 30 is focused, the air pressure is applied intermittently.

While the workpiece W is being conveyed, there are two timing points: timing 71 (blow ON), when air is supplied, and timing 72 (blow OFF), when air supply is stopped. The time for supplying air per one time at the timing 71 is defined as a first time 81, and the time for stopping the supply air per one time at the timing 72 is defined as a second time 82.

For example, the first time 81 corresponds to the time when the electro-pneumatic regulator is open, and the second time 82 corresponds to the time when the electro-pneumatic regulator is closed. In FIG. 3, the first time 81 is indicated by a solid line, and the second time 82 is indicated by a broken line.

The control portion 52 controls the timings 71 and 72, the first time 81 and the second time 82 using the regulation portion 51. The control portion 52 may as well control other factors such as the pressure of the supplied air.

In the example shown in FIG. 3, the control portion 52 controls the stopping of the air supply so that the number of times of the timings 71 is greater than the number of times of the timings 72. More specifically, there are three times of the timings 71, and there are two times of the timings 72. Further, the control portion 52 controls the stopping of the air supply so that the first time 81 and the second time 82 are equal to each other.

When the air supply to the conveying tube 30 is stopped, the air pressure inside the conveying tube 30 decreases. As a result, the speed of the workpiece W during transport decreases. In this way, by switching between the supply of air and the stopping of the supply of air using the control portion 52, the speed of the workpiece W during transport can be controlled.

In other words, the control portion 52 can control the speed of the workpiece W during transport so that it does not exceed a predetermined speed. As a result, the workpiece W can be conveyed reliably. Reliable transport of the workpiece W means that the workpiece W does not bounce off the jig 3, does not pop out, and does not disassemble during transport.

Specifically, by controlling the speed of the workpiece W during transport, for example, when the workpiece W collides with a recess portion 4 of the jig 3 or the tapered portion 433 of the nozzle 42, it is possible to prevent the workpiece W from being deformed, broken apart, or being misaligned in the recess portion 4 of the jig 3.

For example, the control portion 52 controls the regulation portion 51 to supply air to the conveying tube 30 before the pressure (residual pressure) of the air in the conveying tube 30 becomes zero when the air supply is stopped.

In other words, the control portion 52 controls the regulation portion 51 to supply air at such intervals that the residual pressure does not become zero. In such a case, even when the air supply stops, the residual pressure acts on the workpiece W, and therefore the workpiece W will continue to move inside the conveying tube 30 without stopping.

When the air pressure is reduced to a level lower than the pressure required for the workpiece W to start moving inside the conveying tube 30, the workpiece W may stop inside the conveying tube 30 in some cases. Such cases may create such a cause that the workpiece W is stuck in the conveying tube 30. In the case of such a pressure, even when air is supplied once again, the workpiece W will not start moving.

In this embodiment, the air pressure is set to a level higher than or equal to the pressure required for the workpiece W to start moving inside the conveying tube 30. Therefore, even when the workpiece W stops inside the conveying tube 30, it can start moving once again by supplying air. With this configuration, it is possible to prevent the workpiece W from being stuck in the conveying tube 30.

By setting the air pressure to be equivalent to the pressure required for the workpiece to start moving in the conveying tube 30, or to be a pressure with a somewhat extra margin required for the workpiece to start moving, it is possible to control the speed of the workpiece W while controlling the air pressure.

Further, when switching between the supply of air and the stopping of the supply of air using the regulation portion 51 (for example, an electro-pneumatic regulator), fine adjustments such as adjusting the degree of opening are not required, and therefore it is easy to control using the control portion 52.

Here, the results of the transport test of the workpiece W will be explained. The conditions of the transport test are as follows.

The diameter of the workpiece W is 0.13 mm, and the mass of the workpiece W is 0.02 g. The inner diameter of the conveying tube 30 is 0.5 mm, the outer diameter is 1.59 mm, and the length of the conveying tube 30 is 1.1 m.

As shown in FIG. 3, there are three times of the timings 71, and two times of the timings 72. For example, the first times 81 of the timings 71 are equal to each other, and the second times 82 of the timings 72 are equal to each other.

Under the above-provided conditions, when the pressure of the supplied air is 0.3 MPa and the first time 81 and the second time 82 are 0.05 seconds (sec), it has been confirmed that the workpiece W can be reliably conveyed. In this case, the time taken to convey the workpiece W (from the start of the timing 71 for the first time to the end of the timing 71 for the third time) is 0.25 seconds. Under the above-described conditions, the speed at which the workpiece W is ejected from the nozzle 42 is approximately 70 km per hour. The speed can be measured using a high-speed camera or the like.

Further, it has been confirmed that the workpiece W could be reliably conveyed in a similar way even when the pressure of the supplied air is 0.25 MPa and the first time 81 and second time 82 are 0.05 seconds (sec).

Subsequently, another example of control by the control portion 52 will be explained. FIG. 4 is a timing chart showing another example of control by the control portion 52. In the example shown in FIG. 4, the control portion 52 controls the stopping of air supply so that the first time 81 is shorter than the second time 82.

Here, it has been confirmed that the workpiece W can be reliably conveyed when the pressure of the supplied air is 0.3 MPa, the first time 81 is 0.05 seconds, and the second time 82 is 1.0 seconds. Note that the other conditions are similar to those of case provided above.

Note that the air pressure is higher than or equal to the pressure required for the workpiece W to start moving inside the conveying tube 30, and therefore even if the second time 82 is prolonged to stop the workpiece W inside the conveying tube 30, the workpiece can still be conveyed.

It has been confirmed that the workpiece W can be reliably conveyed even when the pressure of the supplied air is 0.3 MPa, the first time 81 is 0.03 seconds and the second time 82 is 0.05 seconds.

As described above, the conveyance device 100 and the conveyance method with the above-described configuration can stably transport the workpiece W. In addition to the above explanation, various other advantageous effects can be obtained from this embodiment.

Further, if there are multiple times of timings 71 and timings 72 while the workpiece W is being conveyed, the lengths of the first time 81 and the second time 82 may be different from each other. The conveyance device 100 may as well comprise other elements. The other elements include, for example, a means for placing the workpiece W on the table 10 and a means for monitoring the workpiece W.

The means for monitoring the workpiece W include, for example, a sensor for monitoring the speed of the workpiece W during transport, a sensor for confirming that the workpiece W has passed a predetermined position, and a camera for confirming that the workpiece W has been inserted into the recess portion 4 of the jig 3. The control portion 52 may, for example, acquire information from the means for monitoring the workpiece W described above and control the stopping of the supply of air by the regulation portion 51 based on that information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A conveyance device which conveys a part by air, the device comprising:
a conveying tube including a first end portion and a second end portion, through which the part is conveyed from the first end portion to the second end portion; and
a control unit which controls supply of the air supplied from the first end portion and stopping of the supply of the air, and stops the supply of the air at least once while the part is being conveyed.

2. The conveyance device of claim 1, wherein
the control unit controls the stopping of the supply of the air so that the number of times of the supplying of air is greater than the number of times the supply of the air is stopped while the part is being conveyed from the first end portion to the second end portion.

3. The conveyance device of claim 2, wherein
the control unit controls the stopping of the supply of the air so that a period of the supply of the air per one time and a period of stopping the supply of the air per one time are equal to each other.

4. The conveyance device of claim 2, wherein
the control unit controls the stopping of the supply of the air so that a period of the supply of the air per one time is shorter than a period of stopping the supply of the air per one time.

5. The conveyance device of claim 2, wherein
a pressure of the air supplied is higher than or equal to a pressure required for the part to start moving in the conveying tube.

6. The conveyance device of claim 1, further comprising:
a table connected to the conveying tube and including a pocket in which the part is to be placed; and
an air pipe connected to the table, which supply the air to the conveying tube via the pocket.

7. The conveyance device of claim 6, wherein
the control unit includes a regulation portion installed in the air pipe, which switches between the supply of the air to be supplied to the conveying tube and stopping of the supply.

8. The conveyance device of claim 7, further comprising:
a nozzle provided at the second end portion and having an inner diameter that reduces toward a distal end which ejects the part.

9. The conveyance device of claim 1, wherein
the control unit supplies the air at such intervals that a residual pressure of the air in the conveying tube does not become zero.

10. A conveyance method for conveying a part by air, the method comprising:
controlling supply of the air to be supplied to a conveying tube through which the part is conveyed and stopping of the supply of the air,
wherein
the controlling comprising stopping the supply of the air at least once while the part is being conveyed through the conveying tube.

11. The conveyance method of claim 10, wherein
the controlling comprising stopping the supply of the air so that the number of times of the supply of the air is greater than the number of times of the stopping of the supply of the air while the part is being conveyed.

12. The conveyance method of claim 11, wherein
the controlling comprising stopping the supply of the air so that a period of the supply of the air per one time and a time for the stopping of the supply of the air per one time become equal to each other.

13. The conveyance method of claim 11, wherein
the controlling comprising stopping the supply of the air so that a period of the supply of the air per one time is shorter than a period of the stopping of the supply of the air per one time.

14. The conveyance method of claim 10, wherein
the controlling comprising supplying the air at such intervals that a residual pressure of the air in the conveying tube does not become zero.
